(19) United States
(12) Patent Application Publication
(10) Pub. No.: US 2011/0019649 A1
(43) Pub. Date: Jan. 27, 2011

(54) METHODS AND SYSTEMS FOR MOBILE STATION LOCATION DETERMINATION IN WIMAX

(75) Inventors: Pranav Dayal, San Diego, CA (US); Ayman Fawzy Naguib, Cupertino, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/688,750

(22) Filed: Jan. 15, 2010

Related U.S. Application Data
(60) Provisional application No. 61/148,936, filed on Jan. 31, 2009.
(60) Provisional application No. 61/148,937, filed on Jan. 31, 2009.

(51) Int. Cl. H04J 3/00

(52) U.S. Cl. 370/336

(57) ABSTRACT

Certain embodiments of the present disclosure provide techniques for determining and communicating the location of a mobile station within a wireless communication system.

### CLAIM OF PRIORITY

This application claims the benefit of priority from U.S. Provisional Patent Application Ser. No. 61/148,936, entitled “Methods and Systems Using Position Advertisement Inside Neighbor BS Handoff Message in WiMAX” and filed Jan. 31, 2009, and from U.S. Provisional Patent Application Ser. No. 61/148,937, entitled “Methods and Systems Communicating MS Positioning Information Calculated at a Serving BS in WiMAX” and filed Jan. 31, 2009, both of which are assigned to the assignee of this application and are fully incorporated herein by reference for all purposes.

### TECHNICAL FIELD

Certain embodiments of the present disclosure generally relate to wireless communications, and more particularly, to determining a location of a mobile station.

### BACKGROUND

Location-based services (LBSs) generally refer to information services accessible with mobile devices through a mobile network, such as those defined by the Worldwide Interoperability for Microwave Access (WiMAX) standard (IEEE 802.16). An LBS utilizes the ability to make use of the geographical position of the mobile devices. LBS services include services to identify a location of a person or object, such as discovering the nearest banking cash machine or the whereabouts of a friend or employee. LBS services can also include parcel tracking and vehicle tracking services. Furthermore, LBS can also include personalized weather services and even location-based games.

Due to the popularity and potential of LBSs, demand and usage of location information of a mobile device have been increasing sharply. Furthermore, location data occupies a significant amount of resources because of the large size of the location information. Accordingly, what are needed are efficient techniques to determine and transfer location information between a mobile device and a base station.

### SUMMARY

Certain embodiments provide a method for wireless communications. The method generally includes receiving, by a mobile station, a neighbor advertisement message containing location data for a serving base station and at least one neighbor base station and calculating a location of the mobile station using the location data.

Certain embodiments provide an apparatus for wireless communication. The apparatus generally includes logic for receiving, by a mobile station, a message containing location data for a serving base station and at least one neighbor base station and logic for calculating a location of the mobile station using the location data.

Certain embodiments provide an apparatus for wireless communication. The apparatus generally includes means for receiving, by a mobile station, a message containing location data for a serving base station and at least one neighbor base station and means for calculating a location of the mobile station using the location data.

Certain embodiments provide a computer-program product for wireless communication, comprising a computer readable medium having instructions stored thereon, the instructions being executable by one or more processors. The instructions generally include instructions for receiving, by a mobile station, a message containing location data for a serving base station and at least one neighbor base station and instructions for calculating a location of the mobile station using the location data.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates example operations for transmitting location data of base stations to a mobile station in accordance with certain embodiments set forth herein.

FIG. 4A illustrates example components capable of performing the operations of FIG. 4.

FIG. 5 illustrates example operations for determining the location of a mobile station in accordance with certain embodiments set forth herein.

FIG. 5A illustrates example components capable of performing the operations of FIG. 5.

FIG. 6 illustrates an example message exchange for determining a location of a mobile station in accordance with certain embodiments set forth herein.

FIG. 7 illustrates example operations for transmitting location data of a mobile station in accordance with certain embodiments set forth herein.

FIG. 7A illustrates example components capable of performing the operations of FIG. 7.

FIG. 8 illustrates example operations for receiving location data of a mobile station in accordance with certain embodiment set forth herein.

FIG. 8A illustrates example components capable of performing the operations of FIG. 8.

FIG. 9 illustrates an example message exchange for determining a location of a mobile station in accordance with certain embodiments set forth herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

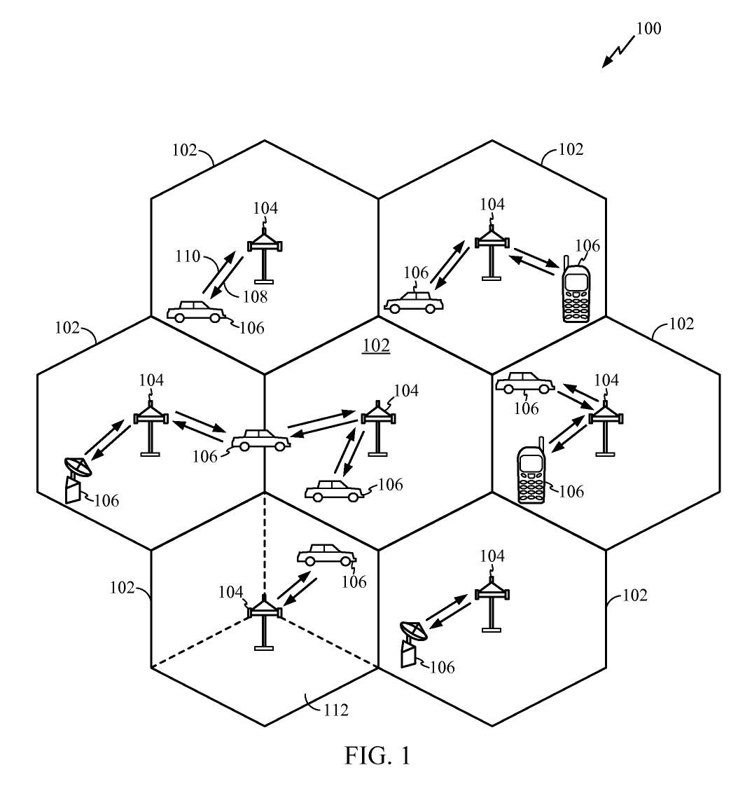

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

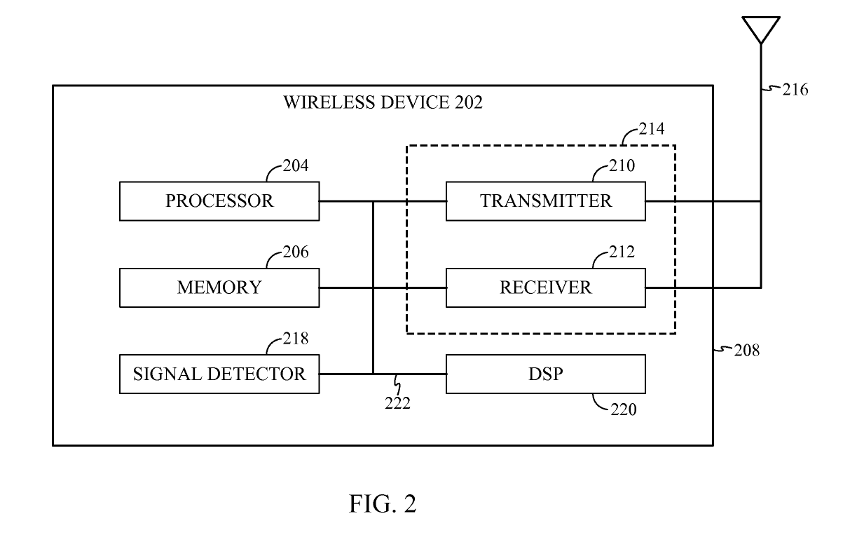

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

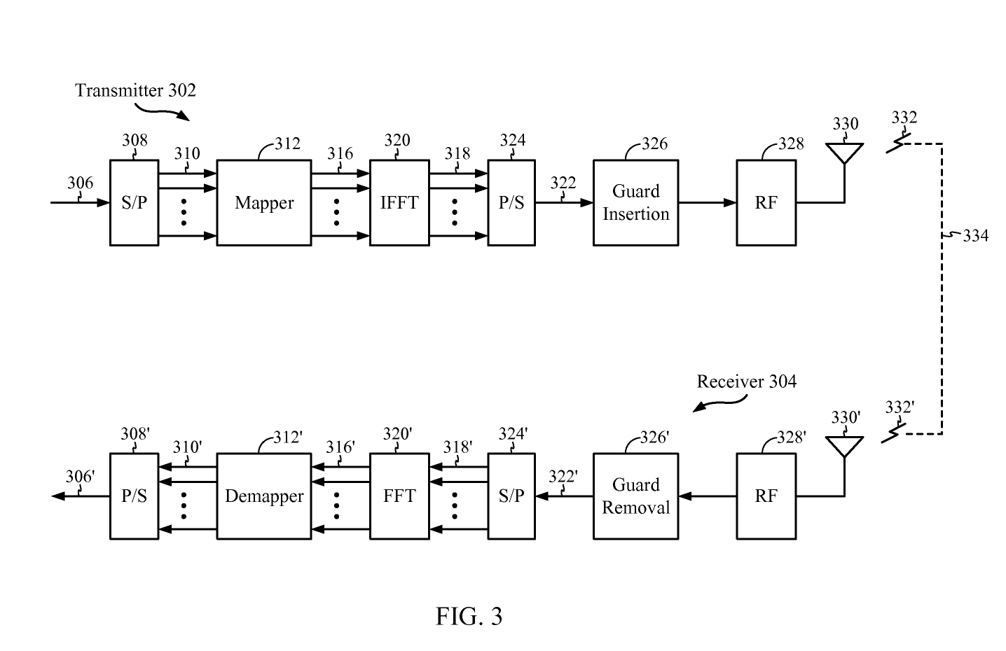

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Determination of Ms Location Based on Bs Location Information Transmitted in MOB_NBR-ADV Message

Certain embodiments of the present disclosure may help support LBSs, for example, by allowing a serving base station (BS) to transmit data regarding its location and location data of neighboring BSs to a mobile station (MS). The location data may be transmitted to the MS, for example, in existing MAC management messages, such as neighbor advertisement (NBR-ADV) messages which are periodically sent. By including location information in an existing message, the overhead and potential latency associated with transmitting a separate message just for the purpose of providing location information to the MS may be avoided.

The MOB_NBR-ADV message may also include a list of the neighboring BSs and network topology information. Transmitting the location data in a message that already contains the list of neighboring BSs may reduce the overhead of re-transmitting the neighbor list in a separate message. In addition, latency in obtaining location data may be reduced by virtue of the MS not having to wait for an additional message containing the location data.

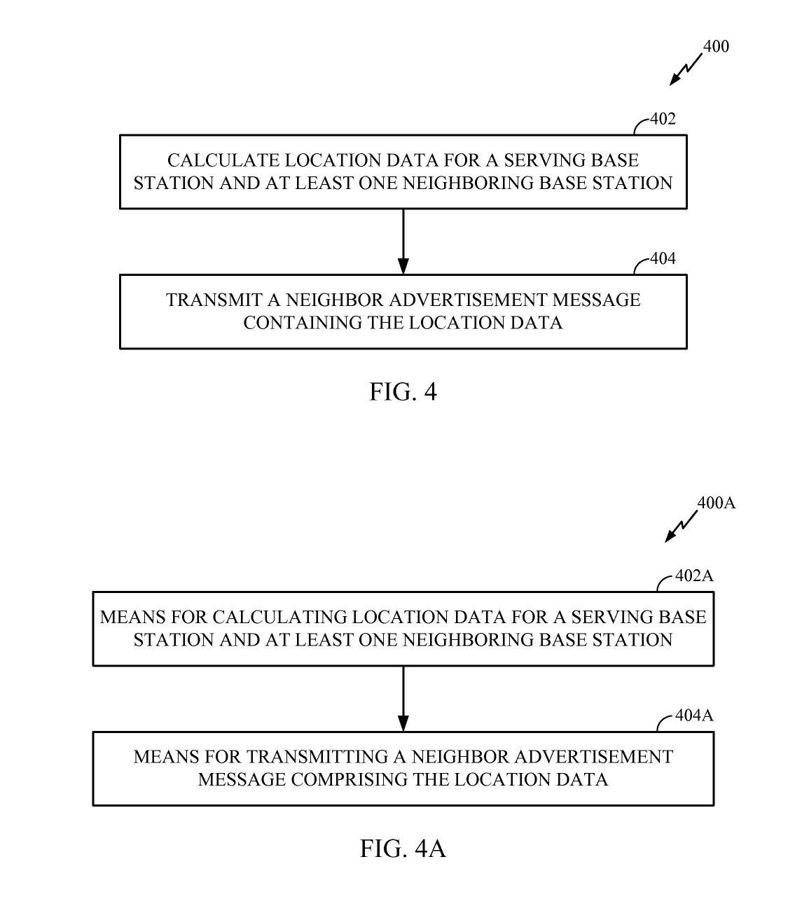

FIG. 4 illustrates example operations 400 that may be performed, for example, by a serving BS, for transmitting location data to an MS, in accordance with certain embodiments set forth herein. At 402, a serving base station determines the location data of itself and neighboring BSs. At 404, the serving BS transmits the location data to the MS, for example, in a MOB_NBR-ADV message that includes an identification of the neighbor BSs and their respective locations.

According to certain aspects, an MS receiving the location data (of the serving BS and/or neighboring BSs) may use the location data to determine its own location. For example, the MS may infer information about its position based on the location of the BSs and other information, as will be described below.

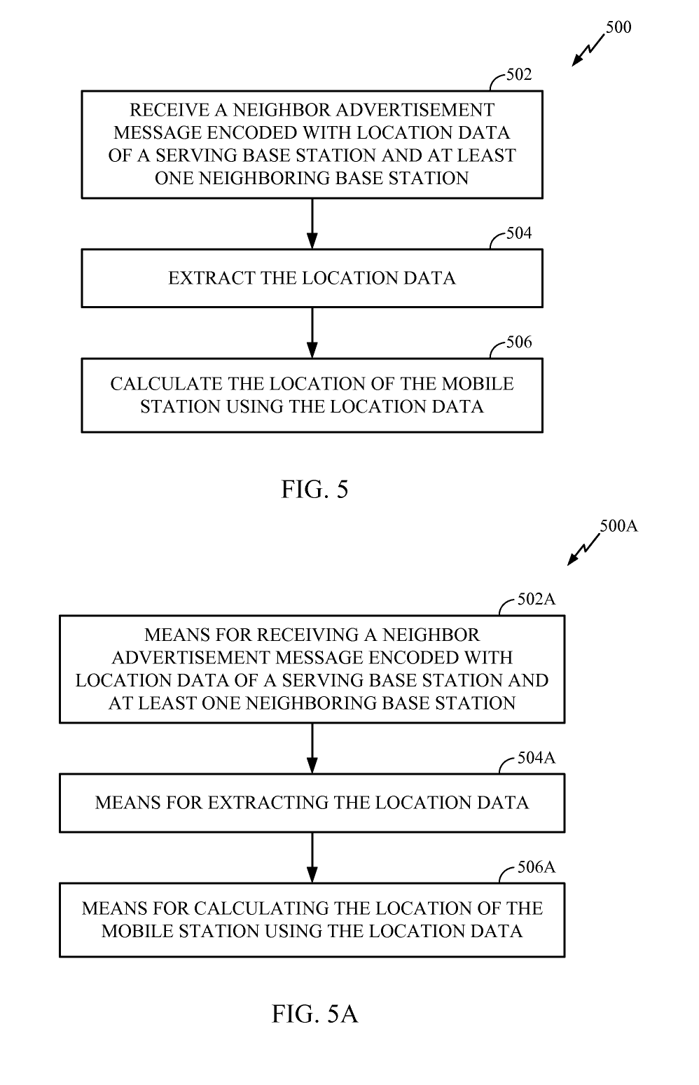

FIG. 5 illustrates example operations that may be performed, for example, by an MS to determine its location based on location information of serving and neighbor BSs transmitted in MOB_NBR-ADV message. At 502, the MS receives location data in a message (e.g., in a MOB_NBR_ADV message), from the serving BS. At 504, the MS extracts the location data of the neighboring BSs and the serving BS from the message. At 506, the MS calculates its location using the location data of the serving BS and the neighboring BSs.

For certain embodiments, using the location data of the serving and neighbor BSs, the MS may determine its own location by communicating with the different BSs. For example, the MS may communicate with different BSs, measure the arrival time of transmitted signals (indicative of a distance), and utilize a Downlink Time Difference of Arrival (TDOA, or specifically, D-TDOA) algorithm to determine its location based on the different arrival times. D-TDOA is a location determination scheme performed by a MS that measures the difference of time arrival for packet transmission between an MS and multiple BSs. Using the measurements and the known locations of the BSs, a relatively precise location of the MS may be triangulated.

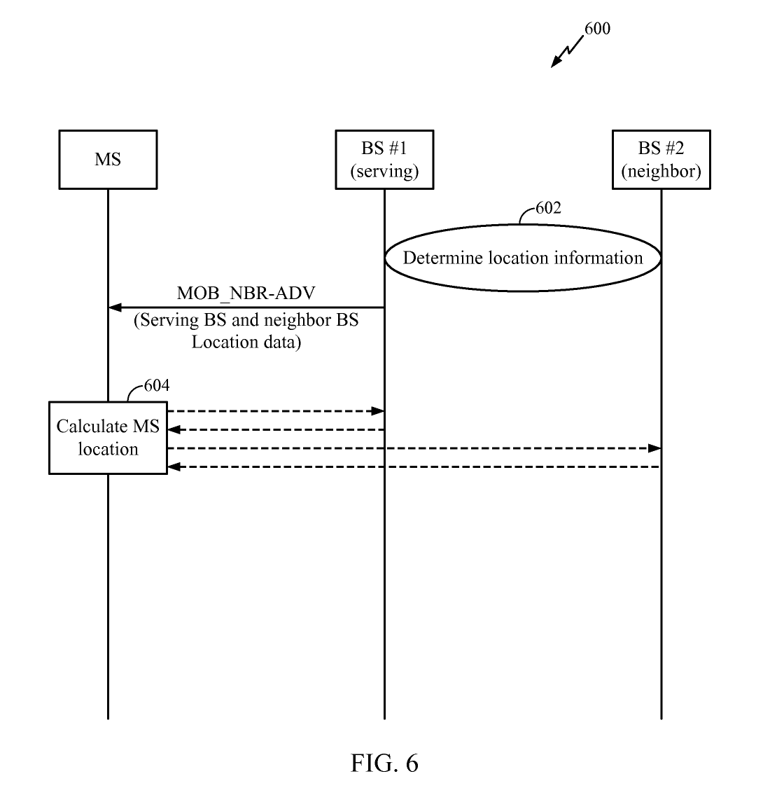

FIG. 6 illustrates an example message exchange 600 corresponding to the example operations shown in FIGS. 4 and 5. To facilitate understanding, the simple example assumes a single MS, serving BS, and a single neighboring BS (i.e., BS #2). However, it should be understood that a typical network may have a plurality of neighboring BSs (e.g., at least 3 as needed to determine position using D-TDOA).

As shown, the serving BS and the neighboring BSs may determine their respective locations, at 602. For example, the BSs may have information regarding their respective locations as a longitude and latitude, GPS coordinates, or any other suitable type of format. The neighboring BSs may share their respective location information with the serving BS through backhaul coordination. Once the location information is collected by the serving BS, the serving BS may then transmit the location information to the MS, contained in a MOB_NBR-ADV message.

At 604, the MS may extract the location information for the BSs and determine its location, for example, using D-TDOA. For example, the MS may measure the difference of time arrival for packets 606 synchronously transmitted from the serving and neighboring BS, and triangulate its location using the measurements and the location information of the BSs.

While the illustrated examples assume D-TDOA algorithms, other algorithms may be used to determine the position of an MS. For example, rather than determine absolute distances to a BS through arrival time, an MS may estimate relative distances through relative received signal strength of signals transmitted from the serving BS and neighboring BSs. Using the relative received signal strength and known location of the BSs, the MS may determine its location, for example, through some type of triangulation.

### Exemplary Transmission of MS Location Information Calculated at a Serving BS

Certain embodiments of the present disclosure may allow a serving base station to calculate the location of an MS and transmit the calculated location to the MS. For example, rather than calculate its own location as described above, an MS may receive its location (calculated by a serving BS) in a Ranging Response (RNG-RSP) message sent by the serving BS.

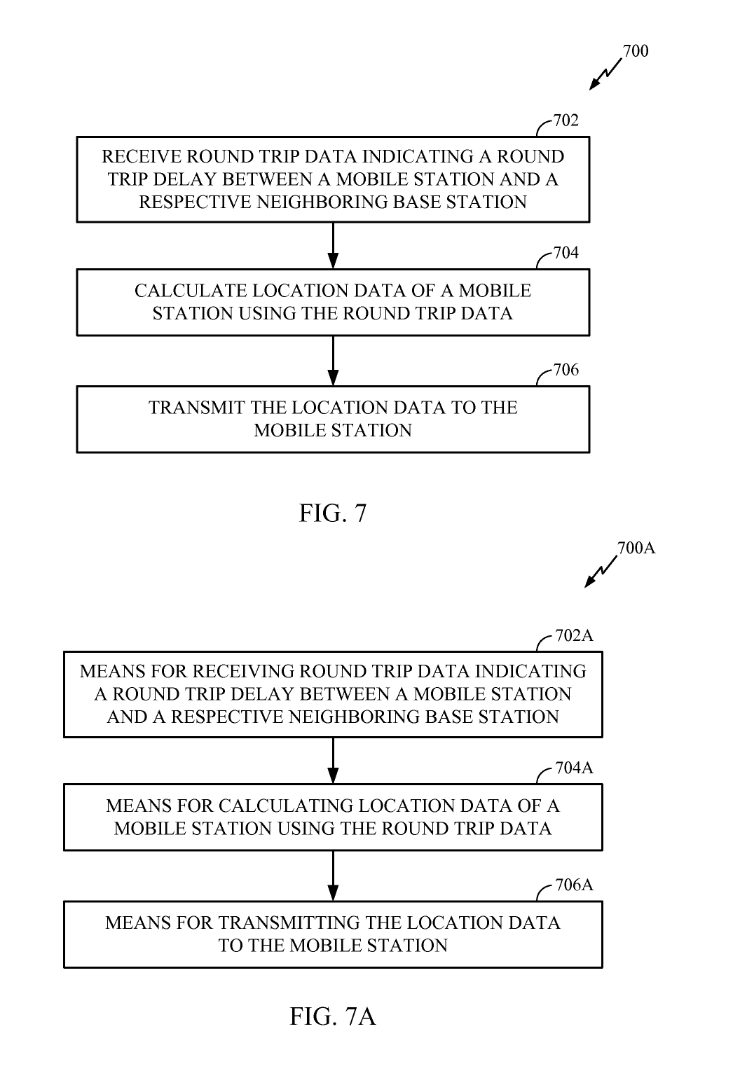

FIG. 7 illustrates example operations 700 for transmitting location data to an MS, in accordance with certain embodiments of the present disclosure. For certain embodiments, a serving BS may calculate the location of an MS using packets transmitted from the MS. For certain embodiments, the packets may comprise ranging codes, the same as or similar to those used in ranging operations.

For example, at 702, the serving BS may receive round trip data indicating a round trip delay between an MS and a respective neighboring BS. According to certain aspects, a UL-MAP (Uplink-Media Access Protocol) message may indicate a ranging slot for the MS to transmit a ranging code to the serving and neighboring BSs. The MS may then transmit ranging codes to the serving and neighboring BSs, which may each determine the round trip data accordingly.

At 704, the serving BS may calculate a location of the MS using the round trip data. For example, the serving BS may determine the location of the MS for example, using an Uplink TDOA (or U-TDOA) algorithm. For example, the BSs may determine arrival time information for the received ranging codes. The neighboring BSs may share the arrival time information with the serving BS through backhaul coordination. Using the collected arrival time information, along with the known locations of the BS, the serving BS may determine the location of the MS.

At 706, the serving BS may transmit the calculated location of the MS to the MS, for example, contained in a Ranging Response (RNG-RSP) message.

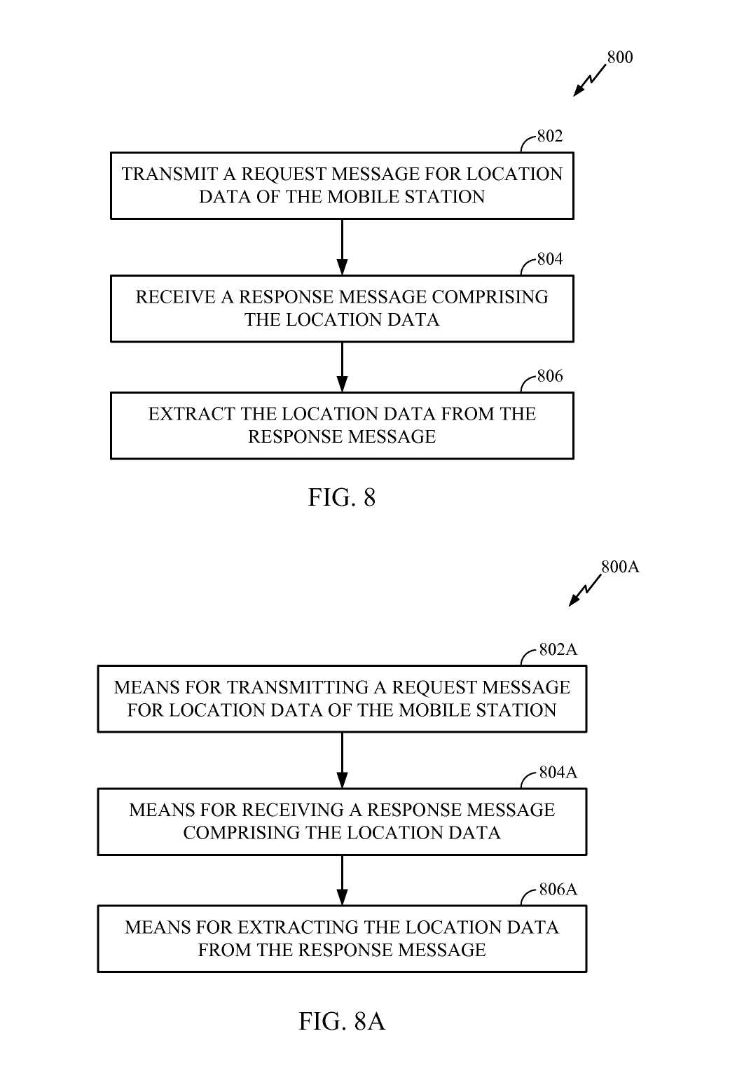

FIG. 8 illustrates example operations 800 that may be performed, for example, by an MS, to obtain location information from a serving BS. At 802, the MS may transmit a request message for location data. At 804, the MS may receive a response message comprising the location data, from the BS. At 806, the MS may extract the location data from the response message.

According to certain embodiments, the operations 800 may be performed as part of periodic ranging and the techniques described herein may allow the MS to obtain its location information during these periodic ranging operations, with little additional overhead.

For example, according to certain embodiments, the MS may send a ranging request and receive a message, for example a UL-MAP message, indicating a ranging slot for the MS to transmit a ranging code. The MS may transmit the ranging code to the serving and neighboring BSs using that ranging slot, allowing the BSs to determine arrival time data. The MS may receive a response message, for example a RNG-RSP, which includes the location of the MS.

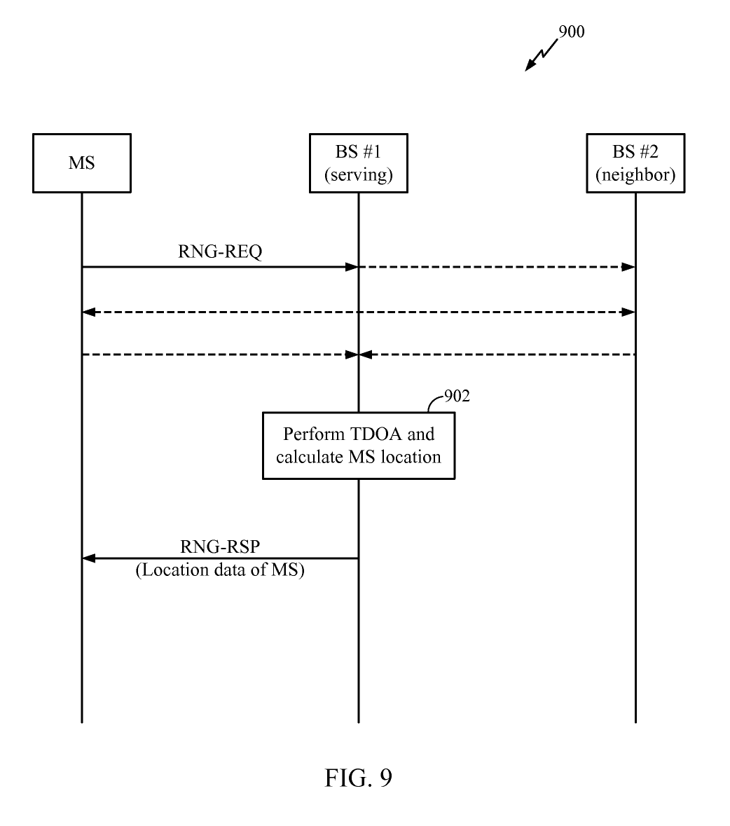

FIG. 9 illustrates an example message exchange 900, for example, in accordance with the operations shown in FIGS. 7 and 8. As illustrated, the MS may send a RNG-REQ to the serving BS. The serving BS may send a response message, after which the MS may send ranging codes, allowing the BSs to determine arrival time data. As indicated, the neighbor BS may send its arrival time data to the serving BS (e.g., via a backhaul connection) for use in calculating the MS location.

According to certain aspects, the serving and neighboring BS perform a pre-negotiated ranging operation to determine a ranging slot for the MS to transmit ranging codes. Thereafter, the serving BS may send a message, for example, a UL-MAP message to notify the MS of the determined ranging slot. Using the ranging slot, the MS may transmit a ranging code to the serving and neighboring BSs.

As shown at 902, the serving BS may calculate the MS location, for example, by using a U-TDOA (Uplink-Time Difference of Arrival) algorithm. For example, each BS may have measured the arrival time of the received ranging code and subsequently share the arrival times with the serving BS through backhaul coordination. The serving BS may then use the difference of time arrivals for the ranging codes, along with the known locations of the BSs, to triangulate a relatively precise location of the MS.

As illustrated, the BS may send the location data back to the MS. For example, the serving BS may transmit the location of the MS to the MS via a Ranging Response (RNG-RSP) message.

The various operations of methods described above may be performed by various hardware and/or software component(s) and/or module(s) corresponding to means-plus-function blocks illustrated in the figures. Generally, where there are methods illustrated in figures having corresponding counterpart means-plus-function figures, the operation blocks correspond to means-plus-function blocks with similar numbering. For example, operations 400, 500, 700, and 800 illustrated in FIGS. 4, 5, 7, and 8 correspond to means-plus-function blocks 400A, 500A, 700A, and 800A illustrated in FIGS. 4A, 5A, 7A, and 8A.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communication, comprising:
receiving, by a mobile station, a message containing location data for a serving base station and at least one neighbor base station; and
calculating a location of the mobile station using the location data.

2. The method of claim 1, wherein the message comprises a neighbor advertisement (MOB_NBR-ADV) message.

3. The method of claim 2, wherein the MOB_NBR-ADV message comprises a list of neighboring base stations and corresponding location data for each neighboring base station in the list.

4. The method of claim 1, wherein the location data comprises at least one of a longitude and latitude of the serving base station and the at least one neighboring base station.

5. The method of claim 1, wherein calculating a location of the mobile station using the location data comprises:
communicating with the serving and neighbor base stations to obtain differential time difference of arrival (TDOA) information; and
utilizing a TDOA algorithm to calculate the location of the mobile station based on the TDOA.

6. The method of claim 5, wherein the TDOA information is obtained by measuring the difference of time arrival of packets synchronously transmitted from the serving and neighbor base stations.

7. An apparatus for wireless communication, comprising:
logic for receiving, by a mobile station, a message containing location data for a serving base station and at least one neighbor base station; and
logic for calculating a location of the mobile station using the location data.

8. The apparatus of claim 7, wherein the message comprises a neighbor advertisement (MOB_NBR-ADV) message.

9. The apparatus of claim 8, wherein the MOB_NBR-ADV message comprises a list of neighboring base stations and corresponding location data for each neighboring base station in the list.

10. The apparatus of claim 7, wherein the location data comprises at least one of a longitude and latitude of the serving base station and the at least one neighboring base station.

11. The apparatus of claim 7, wherein the logic for calculating a location of the mobile station using the location data comprises:
logic for communicating with the serving and neighbor base stations to obtain differential time difference of arrival (TDOA) information; and
logic for utilizing a TDOA algorithm to calculate the location of the mobile station based on the TDOA.

12. The apparatus of claim 11, wherein the TDOA information is obtained by measuring the difference of time arrival of packets synchronously transmitted from the serving and neighbor base stations.

13. An apparatus for wireless communication, comprising:
means for receiving, by a mobile station, a message containing location data for a serving base station and at least one neighbor base station; and
means for calculating a location of the mobile station using the location data.

14. The apparatus of claim 13, wherein the message comprises a neighbor advertisement (MOB_NBR-ADV) message.

15. The apparatus of claim 14, wherein the MOB_NBR-ADV message comprises a list of neighboring base stations and corresponding location data for each neighboring base station in the list.

16. The apparatus of claim 13, wherein the location data comprises at least one of a longitude and latitude of the serving base station and the at least one neighboring base station.

17. The apparatus of claim 13, wherein the means for calculating a location of the mobile station using the location data comprises:
means for communicating with the serving and neighbor base stations to obtain differential time difference of arrival (TDOA) information; and
means for utilizing a TDOA algorithm to calculate the location of the mobile station based on the TDOA.

18. The apparatus of claim 17, wherein the TDOA information is obtained by measuring the difference of time arrival of packets synchronously transmitted from the serving and neighbor base stations.

19. A computer-program product for wireless communication, comprising a computer readable medium having instructions stored thereon, the instructions being executable by one or more processors and the instructions comprising:
instructions for receiving, by a mobile station, a message containing location data for a serving base station and at least one neighbor base station; and
instructions for calculating a location of the mobile station using the location data.

20. The computer-program product of claim 19, wherein the message comprises a neighbor advertisement (MOB_NBR-ADV) message.

21. The computer-program product of claim 20, wherein the MOB_NBR-ADV message comprises a list of neighboring base stations and corresponding location data for each neighboring base station in the list.

22. The computer-program product of claim 19, wherein the location data comprises at least one of a longitude and latitude of the serving base station and the at least one neighboring base station.

23. The computer-program product of claim 19, wherein instructions for calculating a location of the mobile station using the location data comprise:
instructions for communicating with the serving and neighbor base stations to obtain differential time difference of arrival (TDOA) information; and
instructions for utilizing a TDOA algorithm to calculate the location of the mobile station based on the TDOA.

24. The computer-program product of claim 23, wherein the TDOA information is obtained by measuring the difference of time arrival of packets synchronously transmitted from the serving and neighbor base stations.
